(19) United States
(12) Patent Application Publication
(10) Pub. No.: US 2006/0091603 A1
(43) Pub. Date: May 4, 2006

(54) Electronic score pad

(76) Inventor: Gilbert L. Froehlich, Houston, TX (US)

Correspondence Address: LITMAN LAW OFFICES, LTD, PO BOX 15035, CRYSTAL CITY STATION, ARLINGTON, VA, 22215, US

(21) Appl. No.: 11/263,966

(22) Filed: Nov. 2, 2005

Related U.S. Application Data
(60) Provisional application No. 60/624,551, filed on Nov. 4, 2004.

(51) Int. Cl. A63F 13/00; G06F 19/00; A63F 9/00; A63B 71/06

(52) U.S. Cl. 273/148 R; 700/92; 340/323 R; 463/1

(57) ABSTRACT

The electronic scoring device is configured to keep score in games, and to display and total game scores upon user input. The electronic scoring device has a handheld portable housing having a column selection, number selection, and alpha character buttons and a display. Electronic circuitry is connected to the buttons so that a desired number, column or alpha character may be selected. The electronic scoring device may either be powered by a battery or with solar cells disposed on the housing of the device.

### CROSS-REFERENCE TO RELATED APPLICATION

This application claims the benefit of U.S. Provisional Patent Application Ser. No. 60/624,551, filed Nov. 4, 2004.

### BACKGROUND OF THE INVENTION

1. Field of the Invention

The present invention relates to electronic score pads, and particularly to an electronic scoring device that displays and tallies scores for multiple players.

2. Description of the Related Art

Virtually every game that exists requires a tabulation of the score for either an individual or a team, depending on the sport or game involved. Numerous rounds are often needed to complete the game, for example, in the case of gin rummy or baseball. Thus, individuals involved in the game or sport are required to keep a record not only of every score, but also additionally of multiple rounds of scores. When various scores need to be recorded for several rounds and multiple teams or players are involved, the task can be quite cumbersome.

Electronic scoring devices have been created to aid game players in keeping track of and tallying scores, for example, golf score pads or dart scorekeepers. While these devices are able to record some scores, there are problems that arise. For example, often a user is not able to see scoring information for various players or teams at the same time. These devices may not display all of the rounds of the game or may not display both the scoring information and the tallies of the scores simultaneously.

Accordingly, there is a need for an electronic scoring apparatus that displays and tallies multiple scores for multiple players or teams. Thus, the electronic scoring device of the present invention solving the foregoing problems is desired.

### SUMMARY OF THE INVENTION

The electronic scoring device is configured to keep score in games, and to display and total game scores upon user input. The electronic scoring device comprises a handheld portable housing having column selection, number selection, and alpha character buttons and a display. Electronic circuitry is connected to the column selection buttons, the number selection buttons and the alpha character buttons so that a desired number, column or alpha character may be selected.

Users are able to input specific data, such as team names and scores, into the device. A specific column is chosen by the user selecting the appropriate column selection button. The user inputs scores into the columns by depressing the appropriate number selection buttons. The scores are tallied, and a total score for each individual is displayed in one of the cells at the bottom of the column. A team name or player name may be added by the use of the alpha character buttons.

The electronic scoring device may either be powered by a battery or with solar cells disposed on the housing of the device.

These and other features of the present invention will become readily apparent upon further review of the following specification and drawings.

### BRIEF DESCRIPTION OF THE DRAWINGS

FIG. 1 is a plan view of an electronic scoring device according to a first embodiment of the present invention.

FIG. 2 is a block diagram of circuit elements of the electronic scoring device according to the first embodiment of the present invention.

FIG. 3 is a plan view of the electronic scoring device with numbers and letters displayed according to the first embodiment of the present invention.

FIG. 4 is a plan view of an electronic scoring device according to a second embodiment of the present invention.

FIG. 5 is a plan view of an electronic scoring device according to a third embodiment of the present invention.

Similar reference characters denote corresponding features consistently throughout the attached drawings.

### DETAILED DESCRIPTION OF THE PREFERRED EMBODIMENTS

The present invention is an electronic scoring device configured particularly for keeping score in games. The electronic scoring device, designated generally as 10 in the drawings, displays and totals game scores upon user input.

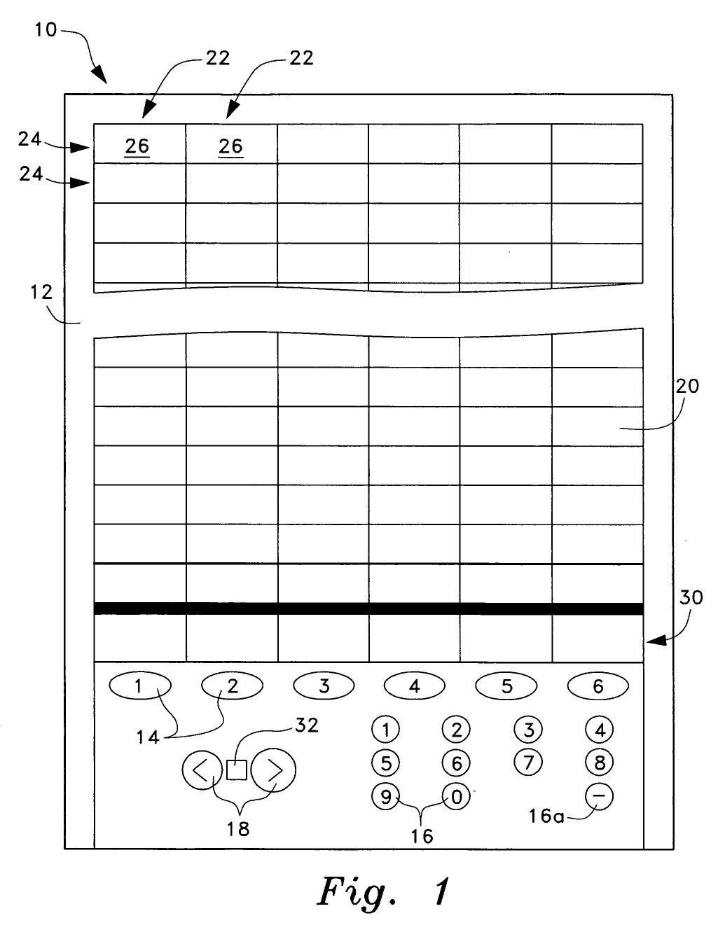

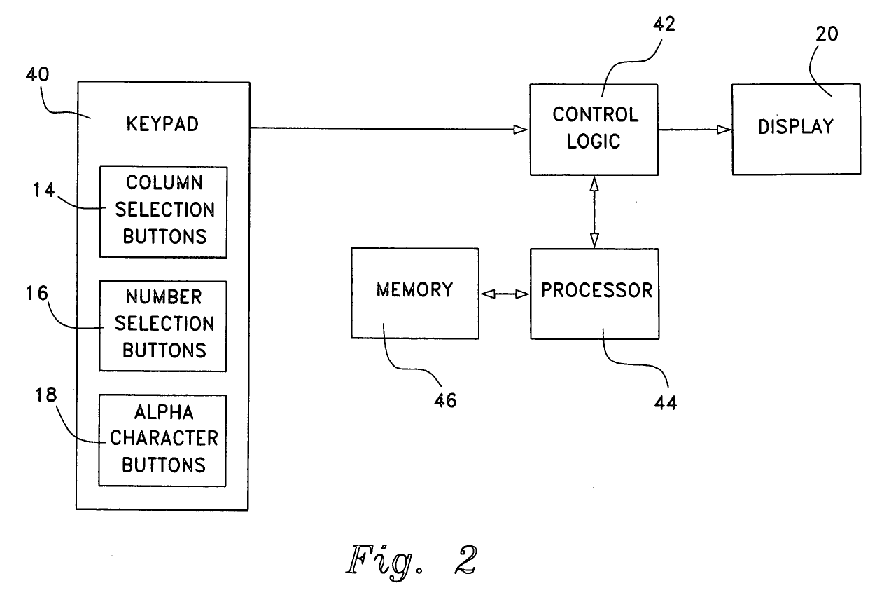

Referring first to FIG. 1, a plan view of the electronic scoring device 10 is shown. The electronic scoring device 10 comprises a handheld portable housing 12 having a plurality of column selection buttons 14, a plurality of number selection buttons 16, a plurality of alpha character buttons 18, and a display 20. Necessary circuit elements (shown in FIG. 2) are connected to the column selection buttons 14, the number selection buttons 16 and the alpha character buttons 18 so that a desired number, a desired column and specific alpha characters can be selected.

The electronic scoring device 10 is a handheld device in which a user may input specific data. The display 20 of the scoring device 10 shows letters and numbers inputted by a user into the device 10, and additionally tallies scores entered by the user. The display 20 may be implemented using a liquid crystal display, light emitting diodes, or gas-plasma technologies. The display 20 has a plurality of columns 22 and a plurality of rows 24, the columns 22 and rows 24 defining a plurality of cells 26. Each cell 26 displays a specific number or letter, based on the input entered by the user.

The housing 12 has a number of buttons 14, 16, and 18 disposed on it. Users input the appropriate character into the electronic scoring device 10 by depressing the particular buttons needed and the characters are shown within the cells 26 of the display 20. Each column selection button 14 is located beneath each column 22 of the display 20, and by depressing the correct button, the individual can select the appropriate column 22 into which they want input entered. The column selection buttons 14 are manually activated by the user. The column selection button 14 selected highlights the first cell column 22, and the user then enters the letter or number desired into the cells 26 of the column 22. Once the appropriate data is entered into the first cell 26 of the specified column 22, the next cell 26 in the column 22 is highlighted, and additional data is entered. This process continues through the length of the column 22 selected.

The number selection buttons 16 are located toward the bottom of the housing 12. Each button 16 is designated as 0, 1 . . . 9, except button 16a, which is designated as the negative symbol. The individual may use the negative button 16a to input a negative number for accurate scoring purposes.

The alpha character buttons 18 are also located toward the bottom of the housing 12. A user depresses the alpha character buttons to enter letters in order to display a name or a team in an alpha character row 30 located at the bottom of the plurality of rows 24. The alpha character buttons 18 are a pair of buttons that permit a user to scroll through the alphabet in order to select a specific alpha character. When the user stops on the alpha character he wishes to enter into the scoring device 10, the character is either displayed after a sufficient pause that alerts the processor 44 (shown more clearly in FIG. 2) to the user's choice of alpha character, or displayed after an alpha character selection button 32 is depressed.

The electronic scoring device 10 may use a battery (not shown) to power the device 10.

Turning now to FIG. 2, a block diagram is shown illustrating the electronic circuitry necessary for the functioning of the electronic scoring device 10. The keypad, indicated generally as 40, includes the column selection buttons 14, the number selection buttons 16 and the alpha character buttons 18. The keypad 40 is electrically connected to the control logic 42, which interfaces with and drives the display 20. The control logic 42 is coupled to a processor 44. Information is transferred in two directions between the control logic 42 and the processor 44. The processor 44 performs arithmetic and logic operations. The buttons 14, 16, and 18 operate electrical switches that send signals to the processor 44 to execute an operation or function. The processor 44 is bi-directionally coupled to the memory 46. The memory 46 holds instructions and data necessary for the processor 44 to carry out specific operations. The memory 46 may include areas of read only memory (ROM) for permanent storage of information and random access memory (RAM) for temporary storage of information.

The memory 46 may store completed displays in the scoring device 10 for later recall.

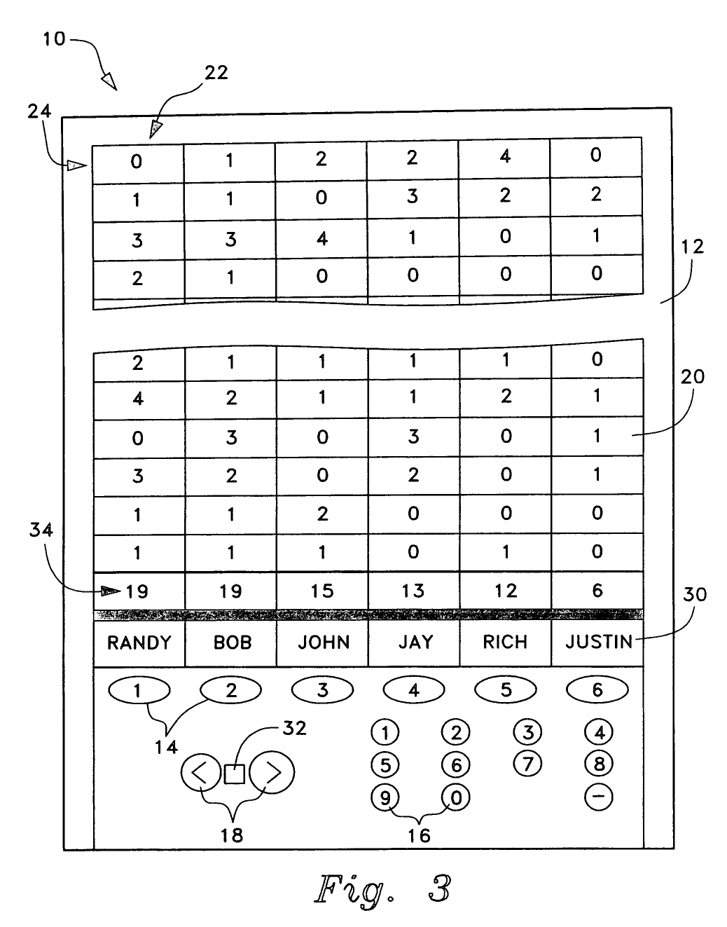

FIG. 3 is a plan view of the electronic scoring device 10 with letters and numbers displayed within the cells 26. The number selection buttons 16 are used to enter a specific number, representing a game score, into the columns 22. The second to last of the plurality of rows 24 is the tallied row 34, which tallies the scores provided in the cells 26 of each column 22. The last row of the plurality of rows 24 is the alpha character row 30. The alpha character row 30 displays team names, individual names or any other combination of alpha characters inputted by the user. The alpha character row 30 is used to determine which player or team received the corresponding scores.

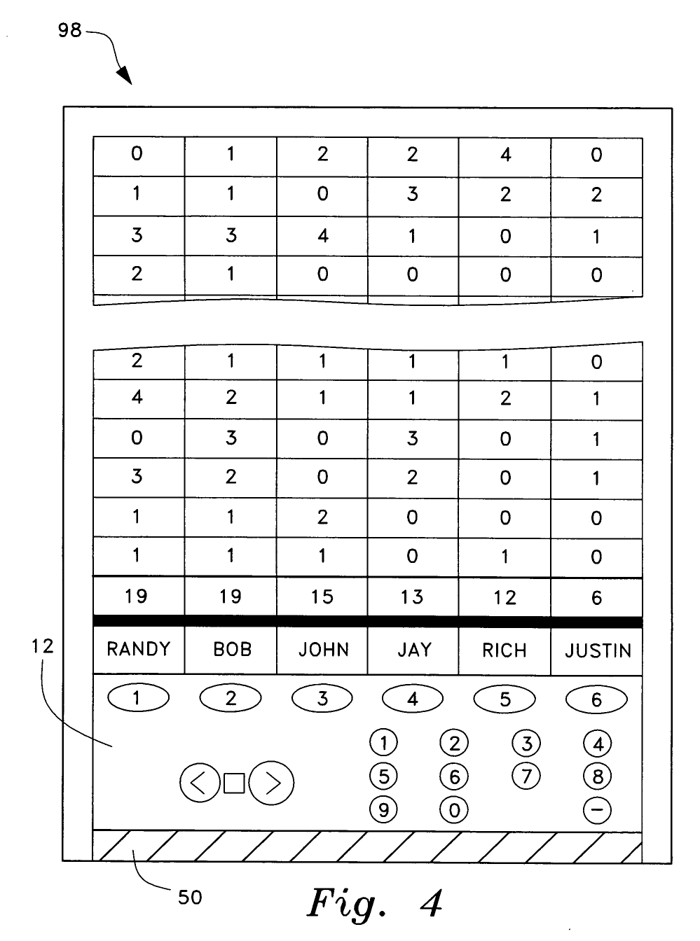

FIG. 4 is a plan view of a second embodiment of the electronic scoring device 98 with the addition of photovoltaic cells 50 or solar cells. Solar cells 50 are disposed on the housing 12 of the device 98. The solar cells 50 convert sunlight into electricity to power the electronic scoring device 98.

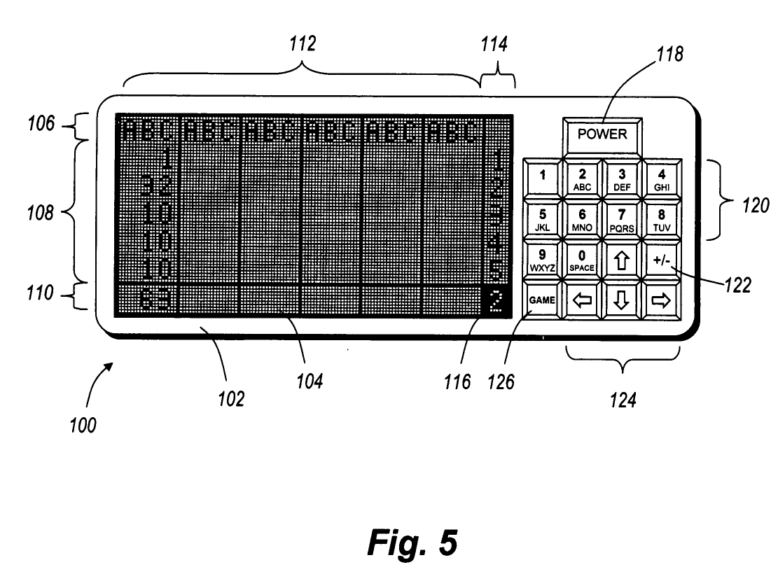

A third embodiment of the present invention is shown in FIG. 5. The electronic scoring device 100 comprises a handheld portable housing 102 having a plurality of cursor buttons 124, a plurality of number and alpha character selection buttons 120, and a display 104. Necessary circuit elements (shown in FIG. 2) are connected to the cursor buttons 124 and the number and alpha character selection buttons 120 so that a desired number, a desired column and specific alpha characters can be selected.

The electronic scoring device 100 is a handheld device in which a user may input specific data. The display 104 of the scoring device 100 is divided, e.g., into seven columns and seven rows and shows letters and numbers inputted by a user into the device 100, and additionally tallies scores entered by the user. The display 104 may be implemented using a liquid crystal display, light emitting diodes, or gas-plasma technologies. The display 104 has a plurality of columns 112 and 114 and a plurality of rows 106, 108, 110, defining a plurality of display cells. Each cell displays a specific number or letter, based on the input entered by the user or calculated by the electronic scoring device 100.

The top row 106 contains initials of each player and identifies each specific column. The bottom row 110 automatically keeps a running total for each of the columns and is not subject to user selection and input like header row 106 and player score input rows 108. Both top 106 and bottom 110 rows remain stationary while the player score input rows 108 can scroll up and down in the display 104. A column of numbers appears in the far right side 114 of the display 104 and defines a column of numbers that identify each round, hand, inning, or incremental scoring segment, etc., played where a score may be input into its associated player or team column.

The housing 102 has a number of buttons 118, 120, 122, 124 and 126, disposed on it. Users input the appropriate character into the electronic scoring device 100 by depressing the particular buttons needed and the characters are shown within the cells of the display 104. Each cursor button 124 enables an individual to select the appropriate display cell into which they want data entered into. Each cursor button is manually activated by the user to move a selection cursor on the display cells up, down, left and right. The selection cursor may appear to blink or may invert video in the display cell that it has selected. The cursor buttons 124 highlight a display cell, and the user then enters the letter or number desired into the cells of the specific column 112.

Pressing a number and alpha character key while in the top player or team row 106 shifts through letters for that key. After the desired letter is displayed, the cursor keys 124 move the cursor to the next character field to enter the next alpha character. Once the player or team name is entered into the first cell of a specified column, the next blank display cell in the column is selected, and additional data is ready to be entered. A player or team score number is entered and the device automatically selects the next blank display cell for the next player or team score. This process continues throughout the length of the column 112 selected.

Each number and alpha character selection button 120 is designated as 0, and 1-9, wherein each number from 2 through 9 has corresponding alpha characters and the “0” key has a “space” character associated with it. The alpha characters may also be selected by a user depressing the number alpha character buttons 120 to scroll through pre-designated numbers and letters in order to display a name or a team in an alpha character row 106 located at the top of the plurality of rows or in the score number rows 108 of the columns 112 when so desired. When the user stops on the alpha character he wishes to enter into the scoring device 100, the character is either displayed after a sufficient pause that alerts the processor 44 (shown more clearly in FIG. 2) to the user's choice of alpha character or displayed after an number alpha character selection button 120 is depressed.

Sign value button 122 is designated as a value-changing symbol. The individual may use the sign value button 122 to input a negative number for accurate scoring purposes, or change a negative number to a positive number to change an input value. A negative score number may be displayed with a leading hyphen, “−”, or the display cell with the negative value may invert video of the display color to designate a negative value associated with a score number.

The lower right hand corner of the display screen 104 designates a game indicator display cell 116, wherein the currently displayed game on the display is designated as “0”, the previous game designated as “−1”, etc. Pressing the game key 126 cycles the scoring device 100 to display all the games stored in the memory of the scoring device. The first time the game key 126 is depressed, a screen without any scores will be displayed, and the capital letter “N” will be in the game indicator display cell 116. If the game key 126 is depressed again without altering any information on the new game screen, then the oldest game that is stored is displayed. Pressing the game key 126 repeatedly will cycle through all saved games until the device 100 reaches the current game screen, indicated by the number “0” in the game indicator display cell 116.

To start scoring for a new game, the game key 126 is depressed until a screen with no scores is displayed and a capital “N” is displayed in the game indicator display cell 116. The initials in the top row 106 will be the same as they are for the previous game. When either any initials are entered into the top row 106 or any score numbers are input into the scoring rows 108, the capital letter “N” in the game indicator display cell 116 will change to a “0”, showing that this is now a new game for scoring. All previous scoring games will be displayed in a negative increment number, i.e., −1, −2, etc., and the oldest game will be erased from memory if the maximum number of games in the scoring device has been achieved.

The electronic scoring device 100 may use a battery (not shown) to power the device 100 or may be powered with the addition of photovoltaic cells or solar cells (as shown in FIG. 4). The power button 118 toggles the power on and off and the electronic scoring device stores all game information in non-volatile memory so that when the device is turned off, the device retains all information stored in memory and resumes the same state upon powering on when the unit was last powered off.

It is to be understood that the present invention is not limited to the embodiments described above, but encompasses any and all embodiments within the scope of the following claims.

I claim:

1. An electronic scoring device, comprising:
a handheld portable housing;
a display having a plurality of display columns and rows defining display cells for displaying alpha characters and numbers, the display being disposed on the housing;
a plurality of column selection buttons disposed on the housing;
a plurality of score number selection buttons disposed on the housing;
a plurality of alpha character buttons disposed on the housing; and
an electronic circuit means connected to the display, the column selection buttons, the score number selection buttons and the alpha character buttons for selecting a desired score number, selecting a desired column and selecting a desired alpha character and entering an alphanumeric entry into the selected cell.

2. The electronic scoring device according to claim 1, further comprising a plurality of solar cells connected to said electronic circuit means, the plurality of solar cells powering the electronic scoring device.

3. The electronic scoring device according to claim 1, further comprising a battery power source connected to said electronic circuit means, said battery power source powering said electronic scoring device.

4. The electronic scoring device according to claim 1, wherein said display is selected from the group consisting of:
a liquid crystal display;
a light emitting diode display; and
a gas-plasma display.

5. The electronic scoring device according to claim 1, wherein each of said plurality of column selection buttons is located beneath each of the respective display columns of said display.

6. The electronic scoring device according to claim 1, further including a negative value symbol button for inputting a negative value to an input score number from said plurality of score number selection buttons.

7. The electronic scoring device according to claim 1, wherein said display further includes an alpha character row comprising a plurality of display cells located at the top or bottom of each of said plurality of display columns, the alpha character row displaying alpha character player names or team names.

8. The electronic scoring device according to claim 1, wherein said electronic circuit means further includes memory for storing sets of scoring display information for later recall.

9. The electronic scoring device according to claim 1, wherein said display further includes an identification display column identifying a game element selected from the group consisting of each round, hand, inning and incremental scoring segment, where corresponding score numbers may be input into corresponding display columns.

10. The electronic scoring device according to claim 1, further comprising:
a game indicator display cell in said display for displaying tables of stored scores; and
a game key connected to said electronic circuit means for cycling displayed tables of stored scores.

11. A method of operating a portable electronic scoring device, said electronic scoring device including a housing, a display having a plurality of columns and rows defining display cells, a plurality of column selection buttons, a plurality of score number selection buttons, a plurality of alpha character buttons, and electronic circuit means connected to said display and said plurality of column, score number and alpha character buttons, said method of operating comprising the steps of:
choosing a specific column on said display;
inputting score numbers into said chosen specific column on said display;
tallying said input score numbers of said chosen specific column; and
displaying a total score based on said step of tallying.

12. The method of operating a portable electronic scoring device according to claim 11, further comprising the step of:
inputting a team or player name associated with said chosen specific column; and
displaying said input team or player name in alpha characters on a top or bottom display cell of said chosen specific column.

13. The method of operating a portable electronic scoring device according to claim 11, wherein each of said plurality of column selection buttons is located beneath each respective column of said display, wherein said step of choosing a specific column on said display further comprises pressing a specific column selection button associated with a respective column of said display to select said specific column.

14. The method of operating a portable electronic scoring device according to claim 11, wherein said step of inputting score numbers into said chosen specific column on said display further includes the step of automatically selecting an adjacent blank display cell in the same chosen specific column after inputting a score number into said chosen specific column.

15. The method of operating a portable electronic scoring device according to claim 11, wherein said display further includes an alpha character row comprising of a plurality of display cells located at the top or bottom of each of said display columns, said method further including the step of inputting at least one alpha character player name or team name in said designated alpha character row, wherein said player name or team name designates associated score numbers within a specific column.

16. The method of operating a portable electronic scoring device according to claim 11, further including the steps of:
selecting to display a first set of stored scores in said electronic scoring device; and
selecting to display a second set of stored scores in said electronic scoring device.
